(19) United States
(12) Patent Application Publication
(10) Pub. No.: US 2025/0086500 A1
(43) Pub. Date: Mar. 13, 2025

(54) Domain-Based Machine-Learned Classifiers

(71) Applicant: Google LLC, Mountain View, CA (US)

(72) Inventors: Alexey Vlaskin, Austin, TX (US); James Heng Guan Ang, Palo Alto, CA (US); Nikhil Sinha, Campbell, CA (US); Dillon Patrick Bly, Fremont, CA (US); John Michael Villwock, Seattle, WA (US)

(21) Appl. No.: 18/465,705

(22) Filed: Sep. 12, 2023

(51) Int. Cl. G06N 20/00; G06N 5/04

(52) U.S. Cl. CPC G06N 20/00; G06N 5/04

(57) ABSTRACT

A machine-learning classification system for a hosted data storage service classifies documents in storage domains of the hosted data storage service. A hosted data storage service can include isolated storage domains that are individually configured to provide domain access by an authorized entity for a domain and prohibit access to the domain by unauthorized entities. A machine-learned domain-specific classifier is associated with a storage domain and is configured to generate a classification label for documents of the entity associated with the respective storage domain. A training system is configured to generate a machine-learned domain-specific classifier using a subset of annotated documents from the selected storage domain.

### FIELD

The present disclosure relates generally to hosted data storage services having isolated domain structures, and more particularly to large-scale classification of documents stored by hosted data storage services.

### BACKGROUND

Hosted data storage services employ multiple server architectures and the like to provide data storage that can be accessed by remote computing devices over networks such as the Internet. Hosted data storage services can be referred to as cloud services. Various computing systems and applications use cloud services for data storage. Hosted data storage services can provide block storage, file storage and/or object storage.

A hosted data storage service can utilize hosted storage domains to provide data isolation and controlled access for an entity such as an organization, business, university, etc. The controlled access can enable access to the hosted storage domain and its data by members of the organization while inhibiting access by entities or members otherwise unassociated with the domain.

### SUMMARY

Aspects and advantages of embodiments of the present disclosure will be set forth in part in the following description, or can be learned from the description, or can be learned through practice of the embodiments.

One example aspect of the present disclosure is directed to a hosted data storage service system including a plurality of storage domains implemented by at least one processor and at least one computer-readable storage media. Each storage domain is configured to store a plurality of documents for an entity associated with the storage domain and prevent access to the storage domain by entities unassociated with the storage domain. The system includes a plurality of machine-learned domain-specific classifiers. Each machine-learned domain-specific classifier is associated with a respective storage domain and is configured to generate a classification label for the plurality of documents of the entity associated with the respective storage domain. The system includes a training system configured to generate the plurality of machine-learned domain-specific classifiers. The training system is configured to train a machine-learned domain-specific classifier for a selected storage domain using a subset of annotated documents from the selected storage domain.

Another example aspect of the present disclosure is directed to a system including one or more processors and one or more computer-readable storage media that store instructions that, when executed by one or more processors, cause the one or more processors to perform operations, the operations include providing, by a hosted data storage service implemented by the one or more processors and the one or more computer-readable storage media, access to a plurality of documents in a plurality of storage domains associated with a plurality of entities. Each storage domain is configured to store documents for an entity associated with the storage domain and prevent access to the storage domain by entities unassociated with the storage domain. The operations include providing a selected document from a selected storage domain to a machine-learned domain-specific classifier associated with the selected storage domain, the machine-learned domain-specific classifier having been trained using a subset of annotated documents from the selected storage domain. The operations include receiving a classification label generated by the machine-learned domain-specific classifier for the selected document.

Another example aspect of the present disclosure is directed to a computer-implemented method that includes providing, by a hosted data storage service implemented by one or more processors and one or more computer-readable storage media, access to a plurality of documents in a plurality of storage domains associated with a plurality of entities. Each storage domain is configured to store documents for an entity associated with the storage domain and prevent access to the storage domain by entities unassociated with the storage domain. The method includes accessing a subset of annotated documents stored in a selected storage domain, providing the subset of annotated documents as training data inputs to a machine-learned domain-specific classifier for the selected storage domain, modifying the machine-learned domain-specific classifier based on the subset of annotated documents to train the machine-learned domain-specific classifier to generate classification labels for the plurality of documents in the selected storage domain, and deploying, by the one or more processors and the one or more computer-readable storage media, the machine-learned domain-specific classifier in association with the selected storage domain.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 is a block diagram of an example computing environment including a hosted data storage service and domain-specific classifiers in accordance with example embodiments of the present disclosure;

FIG. 2 is a block diagram of an example computing environment including a domain-specific training system in accordance with example embodiments of the present disclosure;

FIG. 3 is a block diagram of an example computing environment including a domain-specific classifier in accordance with example embodiments of the present disclosure;

FIG. 4 is a block diagram of an example computing environment illustrating a data flywheel for training a domain-specific classifier in accordance with example embodiments of the present disclosure;

FIG. 5 is a flowchart describing an example method of deploying a domain-specific classifier for an isolated domain of a hosted domain storage service in accordance with example embodiments of the present disclosure;

FIG. 6 is a flowchart describing an example method of training a domain-specific classifier in accordance with example embodiments of the present disclosure;

FIG. 7 depicts a block diagram of an example computing system for training and deploying a domain-specific classifier in accordance with example embodiments of the present disclosure;

FIG. 8 depicts a block diagram of an example computing device that can be used to implement example embodiments in accordance with the present disclosure; and

FIG. 9 depicts a block diagram of an example computing device that can be used to implement example embodiments in accordance with the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

The present disclosure is directed to a machine-learning classification system for classifying documents stored by a hosted data storage service. A hosted data storage service can include isolated storage domains that are individually configured to provide domain access by an authorized entity for a domain and prohibit access to the domain by unauthorized entities. The hosted data storage service can be implemented as a stand-alone cloud data storage service, an email service, a videoconference service, or other hosted service that utilizes the storage service to store data such as code and content in a file structure including individual documents.

To maintain privacy and security between storage domains, the machine-learning classification system includes a domain-specific classifier for individual domains. A training engine of the classification system is configured to train a domain-specific classifier for a selected domain using documents stored in the selected domain. For example, a small subset of documents (e.g., 10-1000 documents) from the selected domain can be labeled and provided as training data for the domain-specific classifier. In this manner, the domain-specific classifier can be trained using domain-specific data for a selected entity while being restricted from accessing data from other isolated domains. The domain-specific classifier can maintain privacy and security of entity data by training solely on data in the selected domain. In this manner, the domain-specific classifier can categorize data such as documents stored in a hosted storage domain while reducing computing resources and personnel time and maintaining isolation of data and categorizations between storage domains.

A domain-specific classifier can be trained or otherwise configured to generate classification labels based on entity-specific training criteria. As an example, many entities can define different classes of documents and assign different security level classification labels to the documents, such as “top secret,” “confidential,” and “public.” A user such as an administrator of the selected entity can annotate the subset of documents with entity-specific labels in accordance with a security classification system for the entity. The subset of annotated documents with security classification labels can then be provided as training data to train the domain-specific classifier to generate document labels based on the entity-specific classification system.

In some examples, the machine-learning classification system includes a personal information removal engine to mask personal information or other sensitive information, such as personally identifiable information, prior to training and/or use of a domain-specific classifier. Masking personal information promotes privacy and security in the machine-learned models deployed for each domain. Documents including masked personal information can be provided to the domain-specific classifiers.

The domain-specific classifier can include a similarity-based machine-learned model in some examples. A similarity-based model can be trained to employ a clustering, nearest-neighbor, and/or other approach to classify documents using an unsupervised learning approach. The domain-specific classifier can additionally or alternatively include a direct inference or inference-based machine-learned classifier that is trained using supervised learning. The direct inference classification model can be trained using supervised learning, for example, by backpropagating a loss function calculated by errors in the predicted classifications generated by the model and the annotated labels of the document.

A domain-specific classifier provides a number of technical effects and benefits for hosted storage services that provide isolated domains for data storage. A domain-specific classifier can be trained using data already stored in a corresponding domain. In this manner, the data is not transferred and stored outside of the domain for training purposes. The data can be maintained in its secure domain throughout its data cycle to avoid privacy and security breaches. Additionally, the domain-specific classifier can be trained using labels and/or training criteria that are specific for a particular domain. As a result, the classifier can generate labels for documents in the domain based on domain-specific training.

Domain-specific classifiers can be especially useful for automatically classifying documents with data sensitivity labels. Unlike general class information such as document type (e.g., form, letter, spreadsheet), data sensitivity classification labels often rely on entity-specific criteria. For instance, the sensitivity labels used by different entities can often be different and/or applied in different manners by different entities. By training a domain-specific classifier, the data sensitivity labels for a particular entity can be used and applied in an entity appropriate manner.

With reference now to the Figures, example embodiments of the present disclosure will be discussed in further detail.

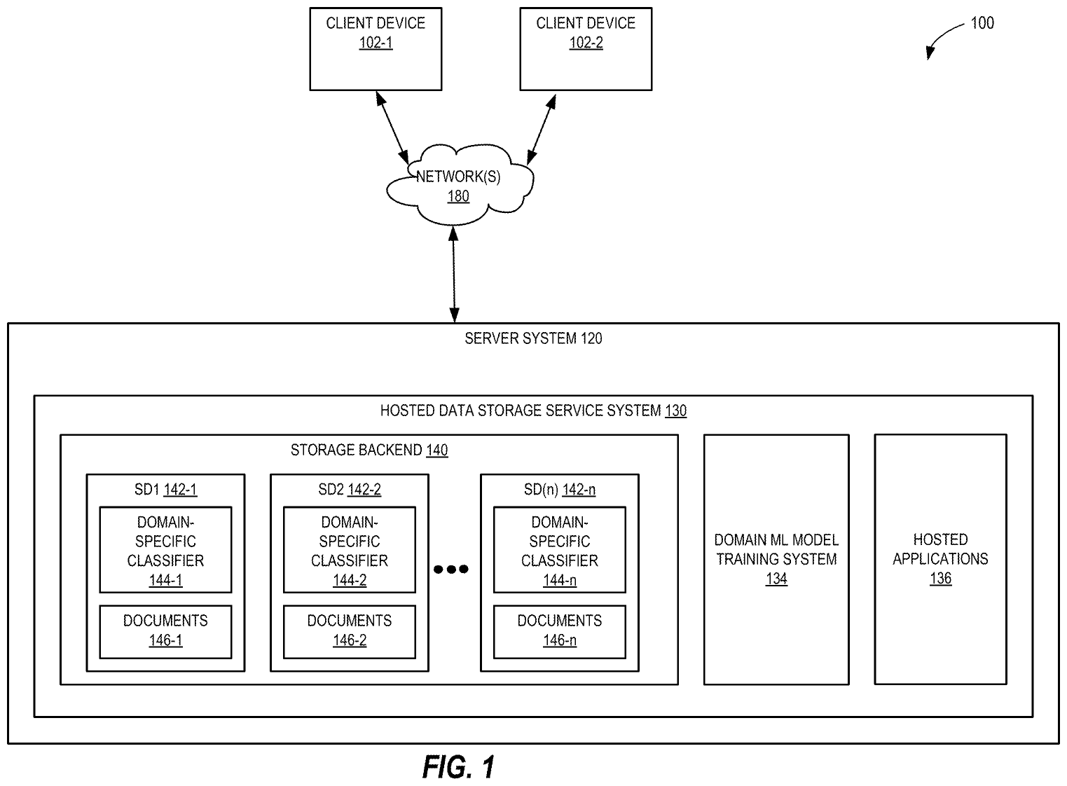

FIG. 1 depicts an example computing environment that can implement a hosted data storage service in accordance with embodiments of the present disclosure. A client-server computing environment is depicted, including client computing devices 102-1 and 102-2 and a server computing system 120 that are connected by and communicate through a network 180. Although two client computing devices 102 are depicted, any number of client computing devices 102 can be included in the client-server environment and connect to server computing system 120 over a network 180. The network 180 can be any type of communications network, such as a local area network (e.g., intranet), wide area network (e.g., Internet), or some combination thereof. In general, communication between the client computing device 102 and the server computing system 120 can be carried via a network interface using any type of wired and/or wireless connection, using a variety of communication protocols (e.g., TCP/IP, HTTP, RTP. RTCP, etc.), encodings or formats (e.g., HTML, XML, etc.), and/or protection schemes (e.g., VPN, secure HTTP, SSL, etc.).

In some example embodiments, the client computing devices 102 can be any suitable device, including, but not limited to, a smartphone, a tablet, a laptop, a desktop computer, or any other computer device that is configured such that it can allow a user to access remote computing devices over network 180. The client computing devices 102 can include one or more processor(s), memory, and a display as described in more detail hereinafter. The client computing devices can execute one or more client applications such as a web browser, email application, chat application, videoconferencing application, word processing application or the like.

The server computing system 120 can include one or more processor(s) and memory implementing a storage backend 140, a domain machine-learned ML model training system 134, and one or more hosted applications 136. The server computing system 120 can be in communication with the one or more client computing device(s) 102 using a network communication device that is not pictured.

It will be appreciated that the term “system” can refer to specialized hardware, computer logic that executes on a more general processor, or some combination thereof. Thus, a system can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

An interface frontend (not shown) can receive messages from the client computing devices 102 and parse the request into a format usable by the hosted data storage service system 130, such as a remote procedure call (RPC) to a storage backend 140. The interface frontend can write responses generated by the hosted data storage service system 130 for transmission to the client computing devices 102. In some implementations, multiple interface frontends are implemented, for example to support multiple access protocols.

The interface frontend can include a graphical front end, for example to display on a web browser for data access. The interface frontend can include a sub-system to enable managed uploads and downloads of large files (e.g., for functionality such as pause, resume, and recover from time-out). The interface frontend can monitor load information and update logs, for example to track and protect against denial of service (DOS) attacks.

Hosted data storage service system 130 includes a storage backend 140 including one or more processors and one or more storage media. System 130 includes isolated storage domains 142 that are individually configured to provide domain access by an authorized entity for a domain and prohibit access to the domain by unauthorized entities. In example computing environment 100, three isolated storage domains 142-1, 142-2, and 142-n are depicted, however, system 130 can include any number of storage domains. Each storage domain is virtually isolated from the other storage domains. For example, each storage domain can be implemented as a virtual machine with individual access restrictions controllable by an entity associated with the domain. Isolated storage domains provide data and code isolation for an entity.

Hosted data storage service system 130 can be implemented as a stand-alone cloud data storage service, an email service, a videoconference service, or other hosted service that utilizes the storage service to store data, code, and the like. Hosted data storage service system 130 can implement one or more hosted applications that provide access to data stored in the storage domains.

In accordance with example embodiments of the present disclosure, hosted data storage service system 130 implements a machine-learning classification system for classifying documents 146 stored in the hosted storage domains 142. Storage domain 142-1 (SD1) stores documents 146-1 for a first entity, which are isolated from documents 146-2 stored in storage domain 142-2 (SD2) and documents 146-n stored in storage domain 142-n (SDn). Similarly, storage domain 142-2 (SD2) stores documents 146-2 for a second entity, which are isolated from documents 146-1 stored in storage domain 142-1 (SD1) and documents 146-n stored in storage domain 142-n (SDn). Storage domain 142-n (SDn) stores documents 146-n for a third entity, which are isolated from documents 146-1 stored in storage domain 142-1 (SD1) and documents 146-2 stored in storage domain 142-2 (SD2). Any number of storage domains can be included in a hosted data storage service. In some examples, in order to stay compliant with regional laws, the hosted data storage service system may support storage and processing in different regions around the globe. For example, European data can be processed in Europe and Australian data can be processed in Australia.

Documents 146 can include any type of file, data structure, or the like that includes text. By way of example, a document 146 may include a word processing file, an email message, a text message, a web page, an image including text, an application user interface, or any other data including text.

To maintain privacy and security between storage domains, the machine-learning classification system includes a domain-specific classifier for individual domains. Domain machine-learned (ML) model training system 134 includes or otherwise implements a training engine that is configured to train a domain-specific classifier for a selected domain using documents 146 stored in the selected domain. For example, a small subset of documents (e.g., 10-1000 documents) from the selected domain can be labeled and provided as training data to train a domain-specific classifier 144 for each domain. Any number of documents can be used as training data. The domain-specific classifier can be trained using domain-specific data for a selected entity while being restricted from accessing data from other isolated domains. The domain-specific classifier can maintain privacy and security of entity data by training solely on data in the selected domain. In computing environment 100, storage domain SD1 includes a domain-specific classifier 144-1 configured to generate classification labels for documents 146-1, storage domain SD2 includes a domain-specific classifier 144-2 configured to generate classification labels for documents 146-2, and storage domain SDn includes a domain-specific classifier 144-n configured to generate classification labels for documents 146-n.

A domain-specific classifier can be configured to generate classification labels based on entity-specific training criteria. As an example, many entities define different classes of documents and assign different security level classification labels to the documents, such as “top secret,” “confidential,” and “public” A user, such as an administrator of the selected entity, can annotate the subset of documents with security classification labels in accordance with a security classification taxonomy for the entity. The subset of labeled documents can then be provided as training data to train the domain-specific classifier to generate document labels based on the entity-specific classification system.

While a single domain-specific classifier is shown for each domain, a domain may include more than one domain-specific classifier or a domain may not include any domain-specific classifier. Some organizations may benefit from one or more specific models for sub-organizational units. For example, one unit of an organization (e.g., a hardware team) may use, interact, or store data unlike other teams (e.g., a software team). As such, a domain may implement and/or include multiple domain-specific modes. The system can provide a model applicable at a sub-domain level. The rest of the organization can utilize a domain-wide model and/or other sub-domain models.

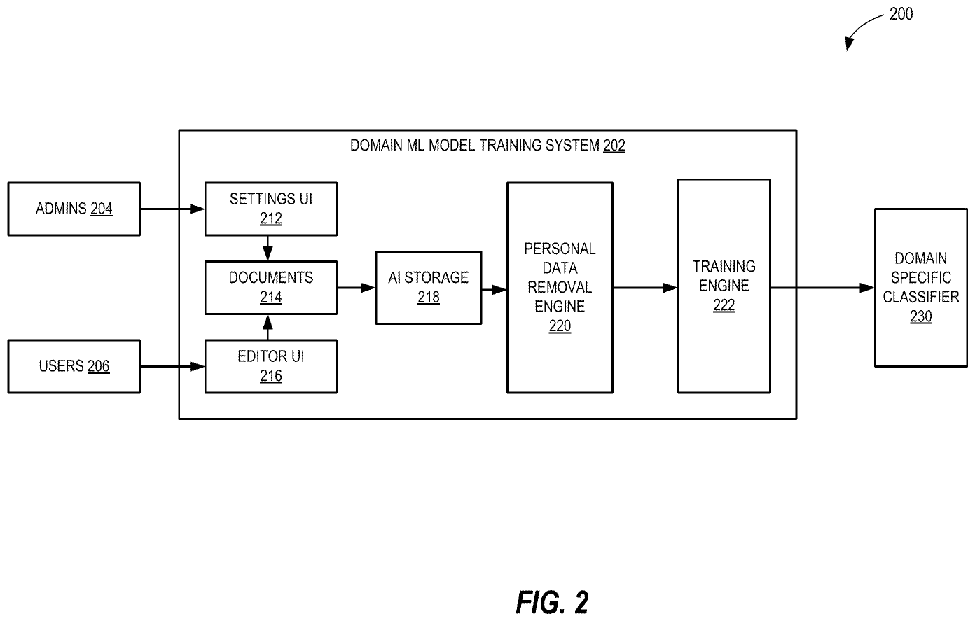

FIG. 2 is a block diagram of an example computing environment 200 including a domain ML model training system 202 in accordance with example embodiments of the present disclosure. Domain ML Model training system 202 is an example implementation of a domain ML model training system 134 depicted in FIG. 1.

Domain ML model training system 202 includes a settings user interface (UI) 212 configured to receive input from an administrative user (administrator) 204 of an entity for a particular domain hosted by the hosted storage service system. Settings UI 212 can include a graphical user interface to provide information to and receive information from the administrator.

An administrator can provide information for a data classification system used by the entity of the domain. For example, many organizations have systems that provide 3-5 classification levels for security classifications of documents. Some organizations use a three-level system including classifications for “confidential,” “controlled,” and “public” documents. Other organizations can use classifications such as “top secret,” “secret,” and “classified.” Some organizations use fewer or additional classification levels such as “L1,” “L2,” L3,” and “L4” classifications. The parameters, use, and application of these various classifications can vary between organizations. The settings UI 212 can receive information from an administrator providing a security or other classification taxonomy for the entity. Settings UI 212 can receive information from the administrator providing the classification levels used by the entity. The settings UI 212 can also receive information from the administrator indicating a subset of documents from the corresponding storage domain that can be used as training data for training the domain-specific classifier. Additionally or alternatively, the settings UI 212 can receive an indication of users (e.g., user id) that are permitted to label the subset of documents. In this manner, the system enables administrators to control the training parameters for the domain-specific classifier. The settings UI 212 can also be used to provide reports, audits, and investigative information to the administrator regarding training and performance of the domain-specific classifier.

Domain ML model training system 202 includes an editor UI 216 configured to receive input from an authorized user 206 of an entity for assisting with training the domain-specific classifier for a domain of the entity. Editor UI 216 can include a graphical user interface to provide information to and receive information from the users. Editor UI 216 is configured to enable users to create, modify, and/or receive documents 214 or other files indicated by the administrator. The documents 214 can remain in the hosted domain of the entity. By way of example, editor UI 216 can be configured for a user 206 to provide classification labels for the subset of documents indicated by the administrator as training data for the system. In some examples, user 206 can review labels generated for documents by the domain-specific classifier and accept or change the label generated by the classifier. The editor UI 216 can also facilitate the user providing feedback on any label changes.

The subset of documents including classification labels provided or accepted by the users 206 can be stored in AI storage 218 in some examples. AI storage 218 can be temporary storage provided in the hosted storage domain of the corresponding entity in some examples.

The training data can be provided from AI storage 218 to a personal data removal engine 220 in some examples. Removal engine 220 is configured to mask sensitive information, such as personally identifiable information, prior to training and/or use of the domain-specific classifier. Masking personal information promotes privacy and security in the machine-learned models deployed for each domain. Moreover, masking personal information can avoid the introduction of bias to a model through training using user-specific information and the like. As an example, personally identifiable information can include names, addresses, social security numbers, driver's license numbers, etc. To avoid the introduction of personally identifiable information or bias into the model, the removal engine can identify such information and replace it with generic data such as replacing an actual social security number with a generic placeholder “SSN.” In an example, the sensitive information removal engine can include a heuristics engine that removes and/or masks sensitive information prior to the data reaching the machine-learning system.

The training data, with sensitive information masked, is provided as training data inputs to training engine 222. Training engine 222 uses the training data to train a domain-specific classifier 230. In some examples, a pre-trained classifier can be accessed and modified based on the training data to generate domain-specific classifier 230. In other examples, data for an untrained classifier can be accessed and modified based on the training data to generate domain-specific classifier 230. Classifier 230 can include a similarity-based machine-learned (ML) classification model that is trained using unsupervised learning. The classifier can additionally or alternatively include an inference-based ML classification model that is trained using supervised learning.

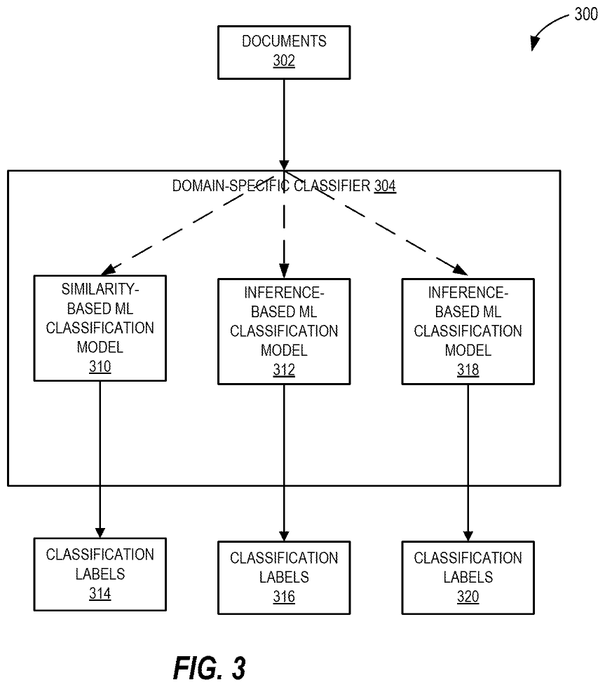

FIG. 3 is a block diagram of an example computing environment 300 including a machine-learned domain-specific classifier 304 in accordance with example embodiments of the present disclosure. Machine-learned Domain-specific classifier 304 includes a similarity-based ML classification model 310, inference-based ML classification model 312, and inference-based ML classification model 318.

Similarity-based ML classification model 310 is configured to generate a classification label 314 for an input document 302. Similarity-based ML classification model 310 can be trained by embedding documents from the training data into a representation space. For example, a small subset of documents (e.g., less than 1000 documents) can be labeled for use as training data for the similarity model. The similarity model can embed each document in an embedding space and cluster documents based on their distance from one another in the embedding space. Clustering can be performed during training and/or after deployment of the model.

The similarity-based ML classification model 310 provides a few-shot text classification approach for training the model to predict one or more classification labels for a document. For example, as few as 10 documents for each classification label can be used to train similarity-based ML classification model 310. This small set of labeled documents can be embedded into the representation space to provide the ability to cluster and determine nearest embeddings to predict labels for unlabeled documents.

After deployment, the document embeddings of the labeled documents can be used to determine labels 314 for unlabeled documents. When an unlabeled document is provided as an input to the model, the model can project the document into the embedding space and identify a document cluster to which the document is closest in the embedding space. For instance, when an unlabeled document is accessed, a clustering or nearest neighbor approach can be used to identify a number (e.g., top-k) of documents that are closest to the document embedding of the unlabeled document. The model can determine a label from the labels for the documents in the document cluster and apply the label to the unlabeled document. A label associated with the number of closest documents can be used to determine a label for the document. If there is agreement (majority, consensus, or other) in the label of the top-k nearest documents, that label can be applied to the document. If there is no agreement, a label can be omitted. In some examples, the system can determine if there is a consensus for the labels in a cluster. If there is consensus, the label can be applied to the unclassified document. If there is not a consensus, a label can be omitted. In some examples, an additional model can be used to determine a consensus-based label.

Similarity-based ML classification model 310 can include or be implemented in association with one or more classification models and/or one or more other machine-learned models such as one or more detections models, one or more segmentation models, one or more augmentation models, one or more generative models, one or more natural language processing models, and/or one or more optical character recognition models. The various models can include transformer models, neural radiance field models, one or more diffusion models, and/or one or more autoregressive language models. Similarity-based ML classification models can include one or more neural network layers that perform one or more functions such as feature detection, feature embedding, and classification. For instance, feature extraction and embedding can be utilized to locate a cluster of documents using a nearest neighbors or other approach.

The inference-based machine-learned (ML) classification model 312 provides a supervised text classification approach to predict one or more classification labels for a document. For example, an inference-based ML classification model can be trained by embedding document content into a representation space using a combination of content-based and contextual features. Feature extraction can be done as a processing step and separated from the model. The model can be pre-trained using contrastive learning. The last N layers of the model can be trained using entity-specific training data. For example, supervised learning can be used to modify the last N layers of the model by computing a loss function based on errors detected in predicted classification labels for the training data. This pretraining and supervised training of the last N layers can generate a lightweight model.

In some examples, a user or administrator for an entity can review document labels generated by the similarity model and approve or make corrections to the labels where appropriate. Documents with approved or corrected labels can be provided as training data to further train and improve the similarity model. When a threshold amount of labeled documents are generated by user annotation and/or approval of the similarity model outputs, the direct inference classification model can be trained using the documents and labels as training data. The direct inference classification model can be trained using supervised learning, for example, by backpropagating a loss function calculated by errors in the prediction outputs of the classification model.

In some examples, an inference-based model can be used instead of a similarity model if the inference-based model has a higher accuracy than the similarity model. For example, each model can be evaluated to determine a machine learning evaluation metric that measures the model's accuracy. For example, an F1 score can be determined for each model for a domain training set. The evaluation metric can combine the precision and recall scores of the model. The evaluation metric can compute how many times a model makes a correct prediction across an entire dataset. User refinement of predictions by the similarity model is one example of how training examples can be produced. In other cases, the training examples are contributed by trusted users within the domain in sufficient quantity to produce a direct inference model from the start.

The use of multiple classifier types (e.g., similarly and inference) can provide technical benefits to encompass a wide range of data regimes with both low and high number of training examples. Using a similarity model as a flywheel to produce an inference model is an example but need not be an included component.

After deployment, the inference-based ML classification model 312 can generate classification labels 316 directly from an unlabeled document. Content-based features and contextual features extracted from an input document can be used by classification model 312 to predict one or more classification labels for the document.

Inference-based ML classification model 312 can include or be implemented in association with one or more classification models and/or one or more other machine-learned models such as one or more detections models, one or more segmentation models, one or more augmentation models, one or more generative models, one or more natural language processing models, and/or one or more optical character recognition models. The various models can include transformer models, neural radiance field models, one or more diffusion models, and/or one or more autoregressive language models. Similarity-based ML classification models can include one or more neural network layers that perform one or more functions such as feature detection, feature embedding, and classification. These layers can be different than the one or more neural network layers of the similarity-based ML classification model. In some examples, the models can utilize one or more shared layers. For instance, feature extraction and embedding can be utilized.

FIG. 3 depicts an additional inference-based ML classification model 318 configured to generate inference-based classification labels 320. The system is generally flexible and can train a set of models with careful evaluation and choose one at the end of the training having the highest evaluation metric, for example. In this respect, any number of similarity-based ML classification and/or inference-based ML classification models can be used.

In some implementations, the machine-learned domain-specific classifier 304 can process image data, text data, audio data, and/or latent encoding data to generate output data that can include image data, text data, audio data, and/or latent encoding data. The one or more machine-learned models can perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask-based segmentation).

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a document classification output. For instance, the machine-learned model(s) can process the latent encoding data to predict output metadata values and/or labels for documents. As a specific example, the machine-learned model(s) can process the latent encoding data to generate an output including security classification labels for documents.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

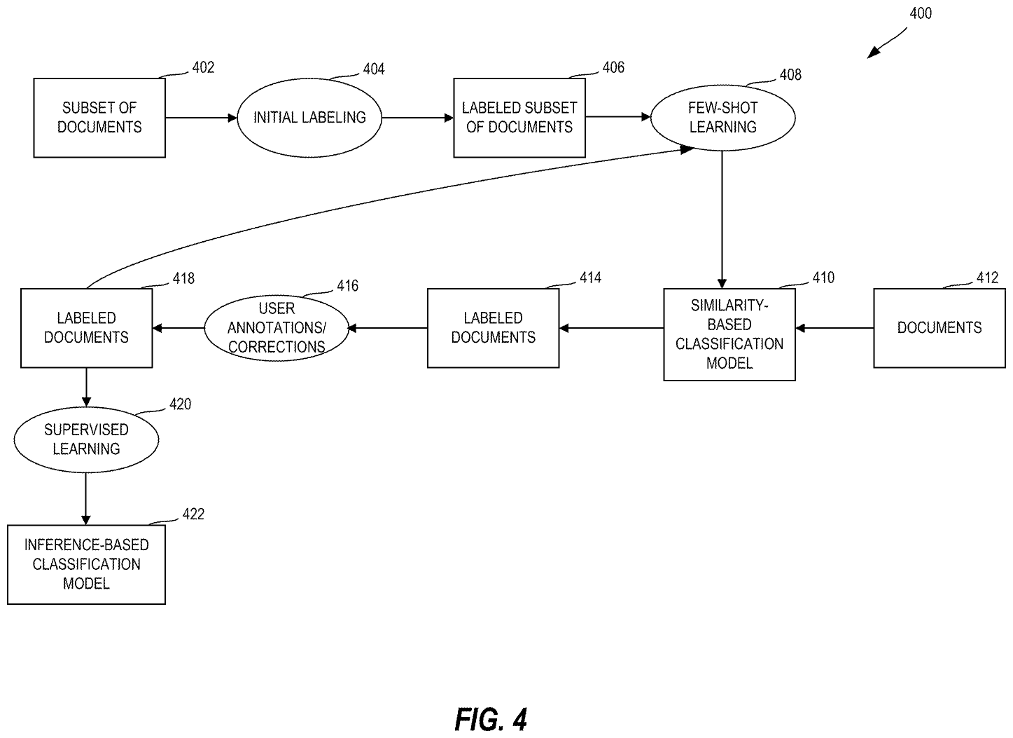

FIG. 4 is a block diagram of an example computing environment 400 illustrating a data flywheel for training a domain-specific classifier in accordance with example embodiments of the present disclosure. FIG. 4 illustrates a process that can be used to first train and deploy a similarity-based classification model using few-shot learning, followed by training and deploying an inference-based ML classification model at least partially based on labels generated by the similarity-based classification model.

A subset of documents 402 for a selected domain are labeled at 404. The subset of documents can be stored in the selected domain and identified via data received from an administrator via a settings UI 212. The administrator can provide data indicating the subset of documents to be used as training data and also provide a classification taxonomy including classification labels for the documents. An authorized user can access an editor user interface (UI) 216 and provide classification labels for the documents using the classification taxonomy identified by the administrator.

The labeled subset of documents 406 is provided as input to train a similarity-based classification model at 408 using few-shot learning. Any few-shot learning suitable for text classification can be used. By way of example, large language models (LLMs) such as PaLM can be used, as these models are naturally enabled for few shot learning. See PaLM: ScalingLanguageModelingwithPathways, Chowdhery et al. arXiv:2204.02311, Oct. 5, 2022, incorporated by reference herein in its entirety. Each document can be embedded into a representation space. A small sample set such as 10 documents for each classification label can be used in some examples. As another example, a sample set of more than 10 documents but less than 100 documents for each classification label can be used. This small set of labeled documents can be embedded into the representation space to provide the ability to cluster and determine nearest embeddings to predict labels for unlabeled documents. Other numbers of documents less than 10 or greater than 100 can be used.

The trained similarity-based classification model 410 can be deployed for generating classification labels for unlabeled documents 412. Unlabeled documents 412 can be provided as input to the similarity-based classification model which generates labeled documents 414. The labeled documents include one or more classification labels determined by the similarity-based classification model 410. Model 410 can embed an unlabeled document into the representation space and determine a top-k nearest embeddings in the representation space. If there is a consensus (majority, etc.) in the label for the top-k nearest neighbors, the label of the neighbors can be applied to the document. If there is no label consensus for the neighbors, the document can remain unlabeled in some examples.

The labeled documents 414 can be presented to a user at 416. For example, the documents with labels generated by the similarity model can be shown to the user via editor UI 216. The user can accept or provide changes such as annotations or corrections to the labels generated by the similarity-based ML classification model. The user can also provide feedback on the label changes. The user acceptances and changes can be used to create an updated set of labeled documents 418.

The updated set of labeled documents can be used as additional training data to further train the similarity-based classification model 410 by few-shot learning at 408. For example, additional embeddings can be generated for the labeled documents which can provide refinement in a nearest neighbor matching approach.

When a sufficient number of labeled documents are generated by user approval or correction of the similarity-based classification model outputs, the updated set of labeled documents 418 can be provided as input to train an inference-based ML classification model at 420 using supervised learning. By way of example, a set of 1000 labeled documents can be sufficient to train an inference-based ML classification model. In other examples, a set of 10,000 labeled documents can be used to train an inference-based ML classification model. Other numbers of labeled documents can be used.

Each document can be provided as input to the inference-based ML classification model which can generate a predicted classification label. The predicted classification label can be compared to the annotated label for the document. A loss function can be computed when an error is detected. The loss function can be used to train the model by updating the machine-learned model (e.g., modify one or more weights) based on the calculated loss function.

The trained inference-based ML classification model 422 can be deployed for generating classification labels for unlabeled documents stored in the storage domain. Although not shown, documents labeled by the inference-based ML classification model can be presented to a user via an editor UI. The user can accept or provide changes such as annotations or corrections to the labels generated by the inference-based ML classification model. The user can also provide feedback on the label changes. Documents including user changes can be used as training data for further refining inference-based ML classification model 422.

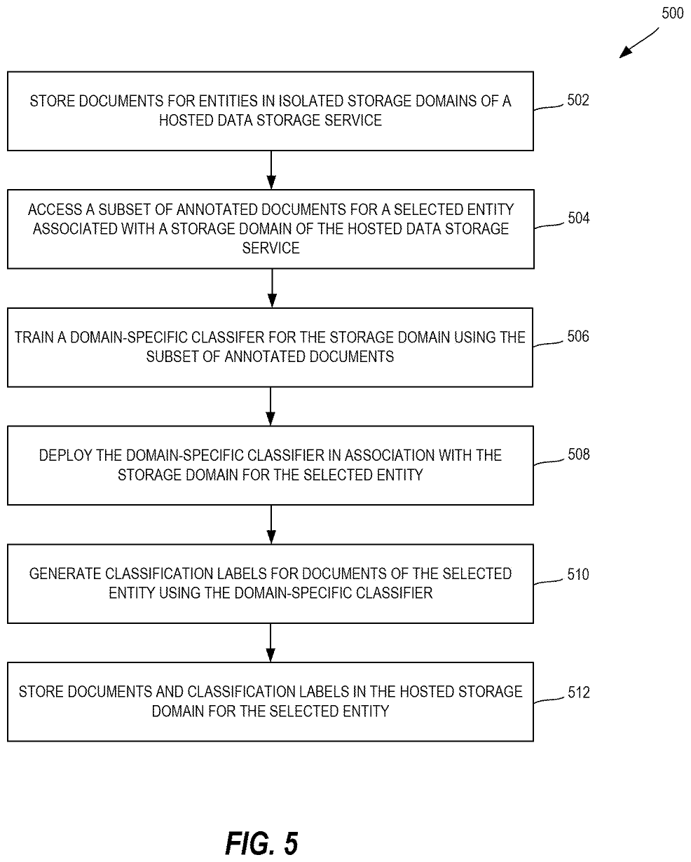

FIG. 5 is a flowchart describing an example method 500 of training and deploying a domain-specific classifier for an isolated domain of a hosted domain storage service in accordance with example embodiments of the present disclosure. One or more portions of method 500 can be implemented by one or more computing devices such as, for example, one or more computing devices of computing environments such as illustrated in FIG. 1-4. One or more portions of method 500 can be implemented as an algorithm on the hardware components of the devices described herein to, for example, perform large-scale document classification of documents stored in an isolated storage domain of a hosted data storage service.

At (502), documents are stored for entities in isolated storage domains of a hosted data storage service. The documents can include any type of data file having text content such as word processing files, spreadsheets, web pages, computer-readable code, etc. Each entity can be associated with a corresponding storage domain and have access to that storage domain. Unauthorized entities unassociated with a storage domain do not have access to the storage domain.

At (504), a subset of annotated documents are accessed for a selected entity associated with a particular storage domain of the hosted data storage service. The annotated documents can be generated via an editor UI that permits authorized users to annotate or otherwise provide classification labels for the subset of documents. The annotated documents can be stored in temporary data storage within the storage domain to maintain privacy and security throughout the training and deployment process.

At (506), a domain-specific classifier is trained for the storage domain using the subset of annotated documents. In some examples, a training system can train a similarity-based ML classification model using unsupervised learning. Training the similarity-based ML classification model can be performed by embedding the subset of annotated documents into a representation space. Clusters of documents can be formed during the training process or after deployment, with clusters representing a set of nearest neighbors in the representation space. In some cases, clusters can be determined dynamically when comparing an unlabeled document embedding to the embeddings of labeled training data. The training system can additionally or alternatively train an inference-based ML classification model using supervised learning. A set of labeled training data can be used to train the inference-based ML classification model. A document can be provided as input to the model which can predict a classification label. A loss function can be computed in response to differences between a predicted classification label and an annotated classification label. The loss function can be used to train the model through backpropagation of errors, for example.

At (508), the trained domain-specific classifier is deployed in association with the storage domain for the selected entity. The domain-specific classifier can be deployed and stored in the storage domain of the selected entity in some examples. In this manner, the classifier is isolated from other storage domains and entities to maintain privacy and security within the selected storage domain. In other examples, the domain-specific classifier can be deployed outside of the storage domain but with access and/or other restrictions to maintain privacy and security for the domain-specific classifier.

At (510), classification labels are generated for documents of the selected entity using the deployed domain-specific classifier. A selected document from the storage domain can be provided as input to the domain-specific classifier. The domain-specific classifier can generate the classification label(s). The classification label(s) can be generated by a similarity-based ML classification model and/or an inference-based ML classification model in embodiments.

At (512), the documents and classification labels are stored in the storage domain for the selected entity.

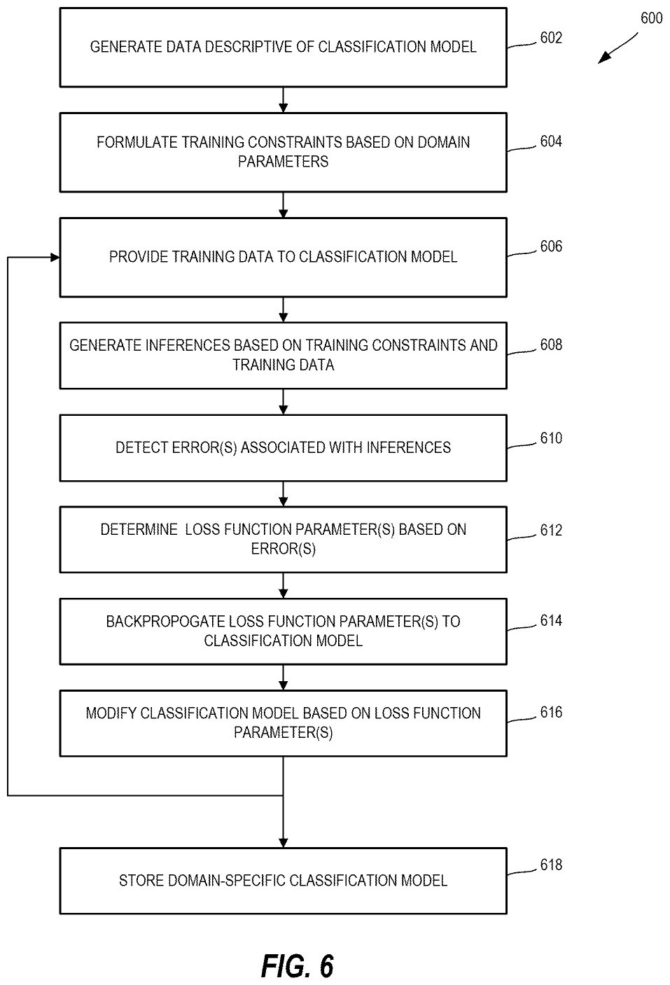

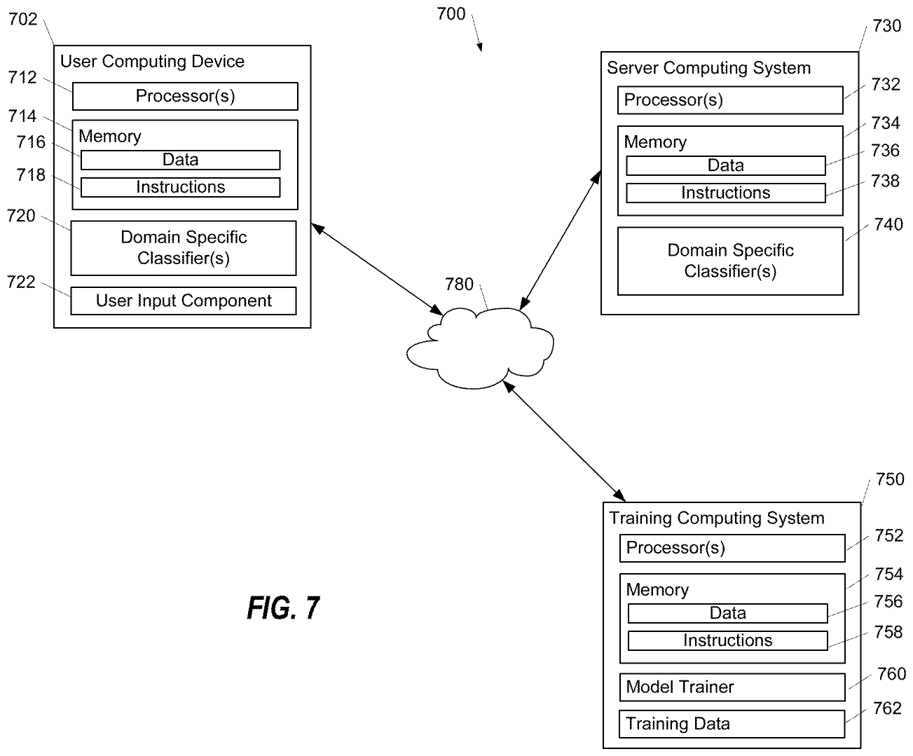

FIG. 6 is a flowchart describing an example method 600 of training a domain-specific classifier in accordance with example embodiments of the present disclosure. One or more portions of method 600 can be implemented as an algorithm on the hardware components of the devices described herein to, for example, train a domain-specific classifier to generate domain-specific classification labels based at least in part on entity-specific training constraints. In example embodiments, method 600 can be performed by a model trainer using training data as illustrated in FIG. 7.

At (602), data descriptive of a domain-specific classifier is generated. Data descriptive of a similarity-based ML classification model and/or an inference-based ML classification model can be generated at 602. In some examples, the data descriptive of the domain-specific classifier is generated at a first computing device, such as a training computing system at which the classifier can be trained end-to-end. In other examples, one or more portions of the data descriptive of the model(s) can be generated or otherwise provided to other computing devices, such as an edge or client computing device at which the model will be provisioned.

At (604), one or more training constraints are formulated based on the domain parameters of the domain at which the machine-learned model will be provisioned. In some examples, training constraints can be formulated from input received from a domain administrator, such as through settings UI 212. By way of example, the training constraints can include a classification taxonomy such as a security classification taxonomy employed by the entity associated with the domain.

At (606), training data is provided to the domain-based classifier. The training data can include annotated documents including classification labels provided by an authorized user in accordance with the entity's classification taxonomy. The documents can be annotated to include or otherwise indicate a classification label associated with the corresponding document data. In some examples as described, the training data can be provided individually to the classifier followed by execution of blocks 608-616 and then repeating with a next document in the training data.

At (608), one or more inferences including a classification label for a document are generated based on the training constraints. For instance, in response to a particular document, an inference can be generated including a predicted classification label to be applied to the document. In some examples, multiple predicted classification labels can be generated along with a probability score for each predicted classification label.

At (610), one or more errors are detected in association with the inferences. For example, the model trainer can detect an error with respect to a classification label that was generated. The model trainer can determine that a predicted classification label is not in agreement with the annotated classification label for a particular document of the training data.

At (612), one or more loss function parameters can be determined for the domain-specific classifier based on a detected error. In some examples, a loss function parameter can include a sub-gradient based on a difference between a predicted label and a ground truth label from the training data.

At (614), the one or more loss function parameters are back propagated to the domain-specific classifier. At (616), one or more portions of the machine-learned model can be modified based on the backpropagation at 614. For example, one or more weights or other parameters of one or more neural network layers can be modified.

At (618), the domain-specific classifier can be stored. The domain-specific classifier can be stored in the storage domain for which it is trained or otherwise stored in association with the storage domain for which it is trained. The classifiers can be isolated form classifiers of other storage domains to enable privacy and secure processing for the intended domain.

FIG. 7 depicts a block diagram of an example computing system for training and deploying a domain-specific classifier in accordance with example embodiments of the present disclosure. FIG. 7 depicts a block diagram of an example computing system 700 that performs large-scale document classification for isolated storage domains according to example embodiments of the present disclosure. The system 700 includes a user computing device 702, a server computing system 730, and a training computing system 750 that are communicatively coupled over a network 780.

The server computing system 730 includes one or more processors 732 and a memory 734. The one or more processors 732 can be any suitable processing device (e.g., a processor core, a microprocessor, a graphic processing unit (GPU), tensor processing unit (TPU), an ASIC, a FPGA, a controller, a microcontroller, etc.) and can be one processor or a plurality of processors that are operatively connected. The memory 734 can include one or more non-transitory computer-readable storage mediums, such as RAM, ROM, EEPROM, EPROM, flash memory devices, magnetic disks, etc., and combinations thereof. The memory 734 can store data 736 and instructions 738 which are executed by the processor 732 to cause the server computing system 730 to perform operations.

In some implementations, the server computing system 730 includes or is otherwise implemented by one or more server computing devices. In instances in which the server computing system 730 includes plural server computing devices, such server computing devices can operate according to sequential computing architectures, parallel computing architectures, or some combination thereof.

The user computing device 702 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 702 includes one or more processors 712 and a memory 714. The one or more processors 712 can be any suitable processing device (e.g., a processor core, a microprocessor, a graphic processing unit (GPU), tensor processing unit (TPU), an ASIC, a FPGA, a controller, a microcontroller, etc.) and can be one processor or a plurality of processors that are operatively connected. The memory 714 can include one or more non-transitory computer-readable storage mediums, such as RAM, ROM, EEPROM, EPROM, flash memory devices, magnetic disks, etc., and combinations thereof. The memory 714 can store data 716 and instructions 718 which are executed by the processor 712 to cause the user computing device 702 to perform operations. The user computing device 702 can also include one or more user input components 722 that receive user input. For example, the user input component 722 can be a touch-sensitive component (e.g., a capacitive touch sensor) that is sensitive to the touch of a user input object (e.g., a finger or a stylus). The touch-sensitive component can serve to implement a virtual keyboard. Other example user input components include a microphone, a traditional keyboard, or other means by which a user can provide user input.

As described above, the server computing system 730 can store or otherwise include one or more domain-specific classifiers 740. For example, the domain-specific classifiers can be or can otherwise include a similarity-based ML classification model and/or an inference-based ML classification model. Example machine-learned models include neural networks or other multi-layer non-linear models. Example neural networks include feed forward neural networks, deep neural networks, recurrent neural networks, and convolutional neural networks. One example model is discussed with reference to FIG. 5.

By way of example, the domain-specific classifiers can be implemented by the server computing system 730 as a portion of a web service (e.g., a hosted data storage service, videoconference service, or other workspace service). Each classifier can be deployed in association with a particular storage domain and include access controls or other restrictions to maintain privacy and security of the classifier relative to other storage domains. In some examples, a domain-specific classifier is stored in the storage domain with which it is associated.

Additionally or alternatively to the classifier(s) 740, in some examples, the user computing device 702 can include one or more portions of a domain-specific classifier, such as one or more models including a similarity-based ML classification model and/or an inference-based ML classification model. The domain-specific classifiers at a user computing device can include access controls or other restrictions to maintain isolation of the classifier from other storage domains. The user computing device can communicate with the server computing system 120 according to a client-server relationship. For example, the classifier(s) 740 can be implemented by the server computing system 730 as a portion of a web service (e.g., an image processing service). Thus, one or more models can be stored and implemented at the user computing device 702 and/or one or more models can be stored and implemented at the server computing system 730. The classifiers 740 can be the same as or similar to the one or more classifiers 720.

In some implementations, the one or more domain-specific classifier(s) can store or include one or more portions of a document classification machine-learned model. For example, the machine-learned model can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

One example classifier 304 is discussed with reference to FIG. 3. However, the example model is provided as one example only.

In some implementations, the one or more classifiers 720 can be received from the server computing system 730 over network 780, stored in the user computing device memory 714, and then used or otherwise implemented by the one or more processors 712. In some implementations, the user computing device 702 can implement multiple parallel instances of the classifier(s) 720 (e.g., to perform parallel inference generation across multiple documents or document instances).

The user computing device 702 and/or the server computing system 730 can train the domain-specific classifiers 720 and 740 via interaction with the training computing system 750 that is communicatively coupled over the network 780. The training computing system 750 can be separate from the server computing system 730 or can be a portion of the server computing system 730.

The training computing system 750 includes one or more processors 752 and a memory 754. The one or more processors 752 can be any suitable processing device (e.g., a processor core, a microprocessor, an ASIC, a FPGA, a controller, a microcontroller, etc.) and can be one processor or a plurality of processors that are operatively connected. The memory 754 can include one or more non-transitory computer-readable storage mediums, such as RAM, ROM, EEPROM, EPROM, flash memory devices, magnetic disks, etc., and combinations thereof. The memory 754 can store data 756 and instructions 758 which are executed by the processor 752 to cause the training computing system 750 to perform operations. In some implementations, the training computing system 750 includes or is otherwise implemented by one or more server computing devices.

The training computing system 750 can include a model trainer 760 that trains a classifier stored at the user computing device 702 and/or the server computing system 730 using various training or learning techniques, such as, for example, backwards propagation of errors. In other examples as described herein, training computing system 750 can train a model prior to deployment for provisioning of the model at user computing device 702 or server computing system 730. The classifiers 720 and 740 can be stored at training computing system 750 for training and then deployed to user computing device 702 and server computing system 730. In some implementations, performing backwards propagation of errors can include performing truncated backpropagation through time. The model trainer 760 can perform a number of generalization techniques (e.g., weight decays, dropouts, etc.) to improve the generalization capability of the models being trained.

In particular, the model trainer 760 can train classifiers based on a set of training data 762. The training data 762 can include for example, a plurality of documents or document instances, where each document has been labeled with ground truth inferences such as document classifications according to an entity classification taxonomy. For example, the label(s) for each training document can describe the class of document (e.g., top secret, confidential, public). In some implementations, the labels can be manually applied to the training data by humans. In some implementations, the models can be trained using a loss function that measures a difference between a predicted inference and a ground-truth inference. In some examples which include multiple models, the models can be trained using a combined loss function that combines a loss at each model. For example, the combined loss function can sum the loss from a first model with the loss from a second model to form a total loss. The total loss can be backpropagated through the model.

In some implementations, if the user has provided consent, the training examples can be provided by the user computing device 702. Thus, in such implementations, the classifiers 720 provided to the user computing device 702 can be trained by the training computing system 750 on user-specific data received from the user computing device 702. In some instances, this process can be referred to as personalizing the model.

The model trainer 760 includes computer logic utilized to provide desired functionality. The model trainer 760 can be implemented in hardware, firmware, and/or software controlling a general purpose processor. For example, in some implementations, the model trainer 760 includes program files stored on a storage device, loaded into a memory and executed by one or more processors. In other implementations, the model trainer 760 includes one or more sets of computer-executable instructions that are stored in a tangible computer-readable storage medium such as RAM hard disk or optical or magnetic media.

The network 780 can be any type of communications network, such as a local area network (e.g., intranet), wide area network (e.g., Internet), or some combination thereof and can include any number of wired or wireless links. In general, communication over the network 780 can be carried via any type of wired and/or wireless connection, using a wide variety of communication protocols (e.g., TCP/IP. HTTP, SMTP, FTP), encodings or formats (e.g., HTML, XML), and/or protection schemes (e.g., VPN, secure HTTP, SSL).

FIG. 7 illustrates one example computing system that can be used to implement the present disclosure. Other computing systems can be used as well. For example, in some implementations, the user computing device 702 can include the model trainer 760 and the training data 762. In such implementations, the classifiers 720 can be both trained and used locally at the user computing device 702. In some of such implementations, the user computing device 702 can implement the model trainer 760 to personalize the classifiers 720 based on user-specific data.

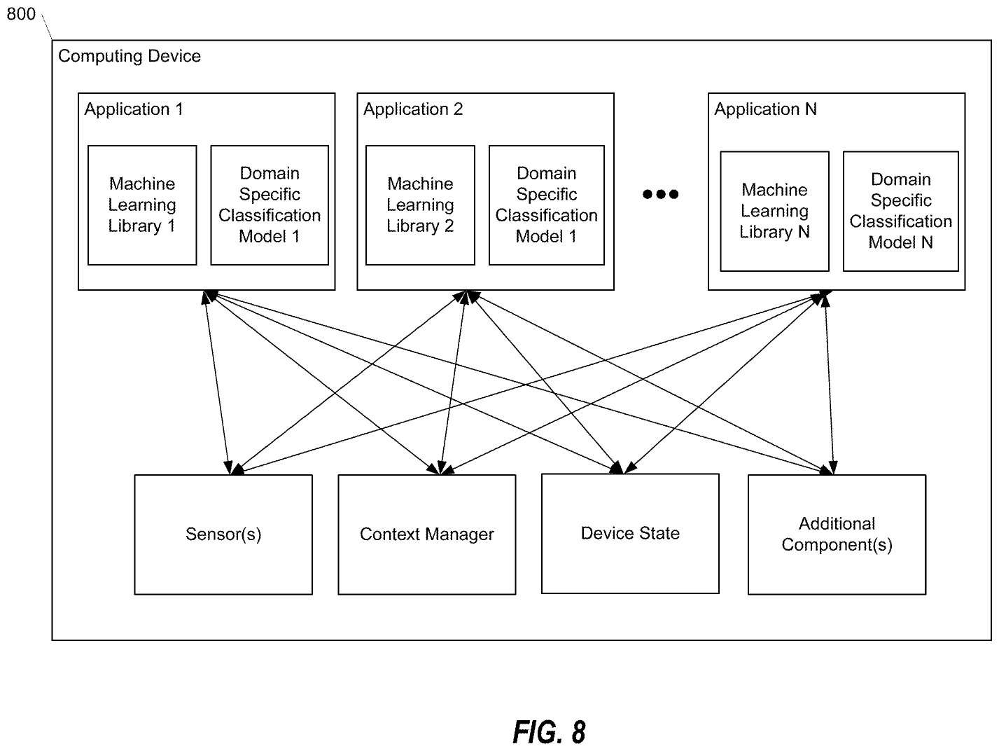

FIG. 8 depicts a block diagram of an example computing device 800 that can be used to implement example embodiments in accordance with the present disclosure. The computing device 800 can be a user computing device or a server computing device.

The computing device 800 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 8, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

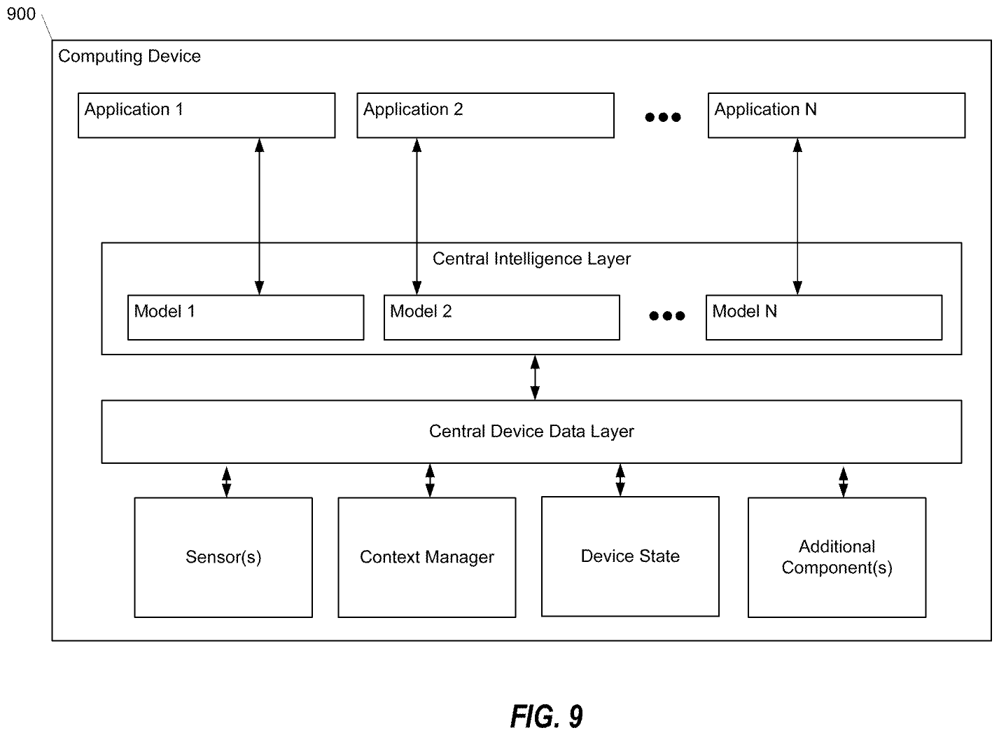

FIG. 9 depicts a block diagram of an example computing device that can be used to implement example embodiments in accordance with the present disclosure.

The computing device 900 can be a user computing device or a server computing device. The computing device 900 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 9, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 900.

The central intelligence layer can communicate with a central device data layer. The central device data layer can be a centralized repository of data for the computing device 900. As illustrated in FIG. 9, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A hosted data storage service system, comprising:
a plurality of storage domains implemented by at least one processor and at least one computer-readable storage media, each storage domain configured to store a plurality of documents for an entity associated with the storage domain and prevent access to the storage domain by entities unassociated with the storage domain;
a plurality of machine-learned domain-specific classifiers, each machine-learned domain-specific classifier associated with a respective storage domain and configured to generate a classification label for the plurality of documents of the entity associated with the respective storage domain; and
a training system configured to generate the plurality of machine-learned domain-specific classifiers, the training system configured to train a machine-learned domain-specific classifier for a selected storage domain using a subset of annotated documents from the selected storage domain.

2. The hosted data storage service system of claim 1, wherein the machine-learned domain-specific classifier for the selected storage domain comprises:
a similarity-based machine-learned classification model configured to generate the classification label for a selected document by embedding the selected document into an embedding space, identifying a document cluster in the embedding space as a nearest match to the selected document, and applying an associated classification label of the document cluster to the selected document.

3. The hosted data storage service system of claim 2, wherein the machine-learned domain-specific classifier for the selected storage domain of the plurality of storage domains comprises:
an inference-based machine-learned classification model configured to generate the classification label for the selected document.

4. The hosted data storage service system of claim 3, wherein:
the machine-learned domain-specific classifier for the selected storage domain comprises a similarity-based machine-learned classification model; and
the inference-based machine-learned classification model is trained using classifications generated by the similarity-based machine-learned classification model.

5. The hosted data storage service system of claim 1, further comprising a heuristics engine configured to:
access the subset of annotated documents prior to the plurality of machine-learned domain-specific classifiers;
identify personal information in the subset of annotated documents;
mask the personal information in the subset of annotated documents; and
provide the subset of annotated documents including the masked personal information to the machine-learned domain-specific classifier for the selected storage domain.

6. The hosted data storage service system of claim 1, wherein:
each storage domain is isolated from other storage domains via one or more access restrictions.

7. The hosted data storage service system of claim 1, wherein:
the classification label identifies one of a plurality of security classifications.

8. The hosted data storage service system of claim 7, wherein:
for a first storage domain and first machine-learned domain-specific classifier, the classification label identifies one of a first plurality of security classifications; and
for a second storage domain and second machine-learned domain-specific classifier, the classification label identifies one of a second plurality of security classifications, wherein at least one of the second plurality of security classifications is different from the first plurality of security classifications.

9. The hosted data storage service system of claim 1, further comprising a settings user interface configured to receive, from an administrator of a selected domain:
data indicative of a security classification taxonomy of an entity associated with the selected domain;
data identifying a subset of documents to be used for training the machine-learned domain-specific classifier for the selected domain; and
data identifying one or more authorized users authorized to annotate the subset of documents according to the security classification taxonomy for generating the subset of annotated documents of the selected domain.

10. The hosted data storage service system of claim 9, further comprising an editor user interface configured to receive, from the one or more authorized users for the selected domain:
data indicative of one or more security classification labels to be applied to each of the subset of documents of the selected domain.

11. The hosted data storage service system of claim 10, wherein the editor user interface is configured to receive, from the one or more authorized users for the selected domain:
data indicative of an acceptance of or a correction to the classification label generated by the machine-learned domain-specific classifier for one or more of the plurality of documents.

12. A system, comprising:
one or more processors;
one or more computer-readable storage media that store instructions that, when executed by one or more processors, cause the one or more processors to perform operations, the operations comprising:
providing, by a hosted data storage service implemented by the one or more processors and the one or more computer-readable storage media, access to a plurality of documents in a plurality of storage domains associated with a plurality of entities, each storage domain configured to store documents for an entity associated with the storage domain and prevent access to the storage domain by entities unassociated with the storage domain;
providing a selected document from a selected storage domain to a machine-learned domain-specific classifier associated with the selected storage domain, the machine-learned domain-specific classifier having been trained using a subset of annotated documents from the selected storage domain; and
receiving a classification label generated by the machine-learned domain-specific classifier for the selected document.

13. The system of claim 12, wherein the machine-learned domain-specific classifier for the selected storage domain comprises:
a similarity-based machine-learned classification model configured to generate the classification label for the selected document by embedding the selected document into an embedding space, identifying a document cluster in the embedding space as a nearest match to the selected document, and applying an associated classification label of the document cluster to the selected document.

14. The system of claim 12, wherein the machine-learned domain-specific classifier for the selected storage domain comprises:
an inference-based machine-learned classification model configured to generate the classification label for the selected document.

15. The system of claim 12, wherein the operations comprise:
identifying personal information in the selected document using a heuristics engine prior to the providing the selected document to the machine-learned domain-specific classifier;
masking the personal information in the selected document; and
providing the selected document including the masked personal information to the machine-learned domain-specific classifier.

16. The system of claim 12, wherein the operations comprise receiving, from an administrator of the selected storage domain via a settings user interface:
data indicative of a security classification taxonomy of an entity associated with the selected storage domain;
data identifying a subset of unlabeled documents to be used for training the machine-learned domain-specific classifier for the selected storage domain;
data identifying one or more authorized users authorized to annotate the subset of unlabeled documents according to the security classification taxonomy for generating the subset of annotated documents of the selected storage domain.

17. The system of claim 12, wherein the operations further comprise receiving, from one or more authorized users for the selected storage domain via an editor user interface, data indicative of one or more security classification labels to be applied to each of the subset of annotated documents of the selected storage domain.

18. A computer-implemented method, comprising:
providing, by a hosted data storage service implemented by one or more processors and one or more computer-readable storage media, access to a plurality of documents in a plurality of storage domains associated with a plurality of entities, each storage domain configured to store documents for an entity associated with the storage domain and prevent access to the storage domain by entities unassociated with the storage domain;
accessing a subset of annotated documents stored in a selected storage domain;
providing the subset of annotated documents as training data inputs to a machine-learned domain-specific classifier for the selected storage domain;
modifying the machine-learned domain-specific classifier based on the subset of annotated documents to train the machine-learned domain-specific classifier to generate classification labels for the plurality of documents in the selected storage domain; and
deploying, by the one or more processors and the one or more computer-readable storage media, the machine-learned domain-specific classifier in association with the selected storage domain.

19. The computer-implemented method of claim 18, wherein:
the machine-learned domain-specific classifier includes a similarity-based machine-learned classification model; and
modifying the machine-learned domain-specific classifier based on the subset of annotated documents includes:
providing the subset of annotated documents to the similarity-based machine-learned classification model;
embedding each annotated document into a representation space of the similarity-based machine-learned classification model; and
storing document embeddings for the subset of annotated documents in the representation space for the similarity-based machine-learned classification model.

20. The computer-implemented method of claim 18, wherein:
the machine-learned domain-specific classifier includes an inference-based machine-learned classification model; and
modifying the machine-learned domain-specific classifier based on the subset of annotated documents includes:
providing the subset of annotated documents to the inference-based machine-learned classification model;
receiving a predicted classification label from the inference-based machine-learned classification model for each of the subset of annotated documents;
determining one or more parameters of a loss function based on a difference between a predicted classification label and an annotated label for each of the subset of annotated documents; and
modifying at least a portion of the inference-based machine-learned classification model based at least in part on the one or more parameters of the loss function.
